(19) United States
(12) Patent Application Publication
(10) Pub. No.: US 2022/0127141 A1
(43) Pub. Date: Apr. 28, 2022

(54) PROCESS AND PLANT FOR PRODUCING CO-RICH SYNTHESIS GAS BY PARTIAL OXIDATION

(71) Applicant: L'Air Liquide, Société Anonyme pour l'Etude et l'Exploitation des Procédés Georges Claude, Paris (FR)

(72) Inventors: Matthias MUELLER-HAGEDORN, Frankfurt am Main (DE); Goekhan ARAS, Frankfurt am Main (DE); Holger SCHLICHTING, Hofheim (DE)

(21) Appl. No.: 17/507,837

(22) Filed: Oct. 22, 2021

(30) Foreign Application Priority Data
Oct. 22, 2020 (EP) 20020488.1

(51) Int. Cl. C01B 3/32; B01J 19/00

(52) U.S. Cl. CPC C01B 3/323; B01J 19/0013; C01B 2203/0255; C01B 2203/0883; B01J 2219/00087; C01B 2203/1241; B01J 2219/00024; B01J 2219/00157; C01B 2203/0811

(57) ABSTRACT

Proposed are a process and a plant for producing a hydrogen- and carbon oxides-containing synthesis gas by partial noncatalytic oxidation of a fluid or fluidizable carbon-containing input stream of fossil origin as a first input stream in the presence of an oxygen-containing oxidant and optionally a moderator to obtain a CO-rich raw synthesis gas. According to the invention a second input stream including a pyrolysis oil obtained from biomass is reacted simultaneously with the first input stream in the noncatalytic partial oxidation.

### CROSS REFERENCE TO RELATED APPLICATIONS

This application claims priority to EP 20020488.1, filed Oct. 22, 2020, the entire contents of which are incorporated herein by reference.

### BACKGROUND

### Field of the Invention

The invention relates to a process for producing a hydrogen- and carbon oxides-comprising synthesis gas comprising a high proportion of carbon monoxide (CO) by partial oxidation of solid, liquid or gaseous carbon-containing input streams of fossil origin, for example liquid fuels such as crude oil, heavy oil or crude oil descendent products, in the presence of an oxygen-containing oxidant, for example air, oxygen or oxygen-enriched air, and a moderator containing steam and/or carbon dioxide. The invention further relates to a plant for performing the process according to the invention and to a process for retrofitting an existing plant for noncatalytic partial oxidation.

### Prior Art

Synthesis gases are gas mixtures containing hydrogen and carbon oxides which are used in various synthesis reactions. Examples thereof are methanol synthesis, the production of ammonia by the Haber-Bosch process or Fischer-Tropsch synthesis.

A commonly used process for producing synthesis gases is autothermal entrained flow gasification of gaseous, liquid or solid fuels by partial noncatalytic oxidation with an oxygen-containing oxidant as described for example in patent publication DE 10 2006 059 149 B4. At the top of a reactor an ignition and pilot burner is arranged centrally and a plurality of gasification burners are arranged with rotational symmetry to the reactor axis. Via the gasification burners the fuel with oxygen and steam as gasification agents is supplied to a gasification space of the reactor in which the fuel is converted into synthesis gas. The hot gasification gas exits the gasification space together with the liquid slag and passes into a quench space cooling zone into which water is injected for instantaneous cooling of raw synthesis gas and slag. The water used as quench medium collects in the bottom portion of the quench space as a water bath so that a quench water fill level forms in the lower region of the quench space. The slag is deposited in the water bath and is removed via a slag discharge. The quenched raw synthesis gas is withdrawn from the quench space in a steam-saturated state and purified in subsequent purification stages. Since the fuel is directly reacted with the oxidant, oxidant and fuel are supplied coaxially or coannularly.

Depending on the employed input materials and the gasification conditions the gasification further produces soot in the form of soot particles. These are likewise deposited in the water bath.

Special technologies for gasification of liquid and gaseous fuels had already been developed by Texaco at the end of the 1940s and by Shell at the beginning of the 1950s. In later years, Lurgi began marketing a third technology which is known as multipurpose gasification (MPG) and was originally developed from the coal gasification process to dispose of the tars produced in said process.

Certain key features of many gasification processes are similar. Many gasification reactors are configured as entrained flow reactors and operate at operating temperatures in the range from 1250° C. to 1450° C. When operating with liquid feeds such processes produce a small amount of residual carbon which is necessary to eliminate the ash from the reactor. The processes differ essentially in the details of the burner design, the method of syngas cooling and the soot handling.

In the Texaco process the oil input material is mixed with steam as a moderator and preheated in a heater. The Texaco burner is water-cooled in that steam and oil are combined via an annular slot surrounding the central oxygen tube.

The process steam is used to atomize the oil input material and good mixing is ensured by swirling the two streams in opposite directions. The reactor itself is an empty, refractory lined vessel. Soot production is about 1% to 2% by weight based on the fuel input.

In one variant of the Texaco process the produced raw synthesis gas is cooled by direct quenching/instantaneous cooling in direct heat exchange with water as the quench medium. In this quench mode the hot raw synthesis gas exits the bottom of the reactor into the quench section via a dip tube. The quenched synthesis gas is saturated with water and exits the quench section at a temperature of about 250° C.

The high water loading makes the quenched gas suitable for CO conversion without further steam addition. The quench removes the majority of the solids, for example soot, in the gas and these are discharged from the quench vessel as a soot-water slurry or “black water”.

Typically employed as input materials for the described partial oxidation/gasification processes are hydrocarbons of fossil origin such as natural gas or crude oil descendent product (for example vacuum distillation residues). Coal too may be employed in finely divided fluidized form, either dispersed in a gas flow (entrained flow) or dispersed in a liquid (slurry). Disadvantages of these processes are the utilization of fossil, nonrenewable resources and the liberation of greenhouse gases resulting both directly during the synthesis gas production process and at the end of the lifecycle from the products produced therefrom.

Research and development efforts are therefore directed at developing renewable zero carbon dioxide or low carbon dioxide processes for producing synthesis gas. Such a process is for example the Bioliq process of the Karlsruhe Institute of Technology described for example in patent publication DE 10151054 A1. Starting from solid biomass it comprises an initial rapid pyrolysis of the biomass. The resulting solid and liquid pyrolysis products are combined to afford a pumpable dispersion and may thus be supplied to a high pressure gasifier and reacted with oxygen to form synthesis gas. However, disadvantages are the separation of the resulting slag from the synthesis gas and the discharging thereof from the high-pressure process, which entails complex process engineering. In addition, analogously to entrained flow coal gasification, the reactor is provided with a water-cooled membrane wall, which reduces the thermal efficiency of the process.

An alternative process, but using only the liquid products of the pyrolysis stage, is described in patent publication WO 9942540 A1. An important fact here is that in the chemical industry large amounts of synthesis gas must be produced and employed for economic operation. Typical gasification plants having a thermal output of for example 250 bis 1000 MW (based on inputs), in the case of wood as the input material having a heating value of about 17 MJ/kg, have an input demand of about 50 to 200 t/h. Such an input material quantity often cannot be secured at acceptable long-term economic and ecological cost.

Processes for combined introduction of ash-rich input materials such as for example coal with biomass or pyrolysis oil have therefore previously been proposed; one example thereof is disclosed by patent publication EP 2236587 A1. However, such processes have the disadvantage that the separation of the resulting slag from the produced synthesis gas entails complex process engineering and the thus employed reactor form, a water-cooled membrane wall, results in a relatively low cold gas efficiency. These slag-forming processes generate a completely vitrified slag which no longer exhibits any leachability. For heavy metal-containing slags this is an advantage but when using biomass this results in essential minerals such as for example phosphorus being continuously removed from nature.

### SUMMARY

The present invention accordingly has for its object to propose a process for producing CO-rich synthesis gas by gasification of carbon-containing fuels where the abovementioned disadvantages are avoided. The invention further relates to a process for retrofitting an existing plant for noncatalytic partial oxidation.

Partial oxidation conditions/gasification conditions are to be understood as meaning the reaction and process conditions known per se to a person skilled in the art, in particular of temperature, pressure and residence time, as discussed in detail in the relevant literature and under which at least partial conversion but preferably industrially relevant conversions of the reactants into synthesis gas products such as CO and hydrogen are affected.

Noncatalytic partial oxidation reactors are to be understood as meaning especially reaction apparatuses such as are described in the textbook “Gasification”, C. Higman, M. van der Burgt, Gulf Professional Publishing, Elsevier (2003), Chapter 5.3 “Entrained-flow Gasifiers” and Chapter 5.4 “Oil Gasification and Partial Oxidation of Natural Gas”. These have in common that the reaction of the input streams with an oxygen-containing oxidant is effected in a reaction chamber having one or more burners which have arranged downstream of them a cooling zone often configured as a quench chamber. The reaction chamber consists substantially of a refractory lined or endowed empty space whose walls are in some embodiments cooled and which especially contains no solid catalyst to promote the partial oxidation reactions.

Fluid connection between two regions or plant components is to be understood here as meaning any kind of connection that enables flow of a fluid, for example a reaction product or a hydrocarbon fraction, from one to the other of the two regions, irrespective of any interposed regions, components or required conveying means.

Fluids are to be understood as meaning substances which continually deform and therefore flow under the influence of shear forces. In this context “fluidizable” is to be understood as meaning that finely divided, for example particulate, solids such as dumped beds are brought into a fluid-like state via process engineering measures such as mixing in order that they are conveyable and move together with the fluid phase.

Atomizing, also referred to as spraying, is the division of a liquid into fine droplets as an aerosol (mist, spray) in a gas as the atomizing medium. The energy required for division of the liquid is taken from the kinetic energy of the atomizing medium.

For the purposes of the present invention, a means is something which makes it possible to achieve, or is helpful in achieving, an objective. In particular, means for carrying out a particular process step are all physical objects which a person skilled in the art would take into consideration in order to be able to carry out this process step. For example, a person skilled in the art will consider means of introducing or discharging a material stream to include any transporting and conveying apparatuses, i.e. for example pipelines, pumps, compressors, valves, which seem necessary or sensible to said skilled person for performance of this process step on the basis of such a person's knowledge of the art.

The recited solid, liquid and gaseous/vaporous states of matter should always be considered in relation to the local physical conditions prevailing in the respective process step or in the respective plant component unless otherwise stated. In the context of the present application the gaseous and vaporous states of matter should be considered to be synonymous.

The term biomass is to be understood as meaning the constituent material of living organisms or parts thereof. In the context of the present invention this is especially to be understood as meaning lignocellulose-containing biomass. A characteristic of biomass is its continuing renewability through re-growth.

Carbon-containing input streams or input materials of fossil origin are to be understood as meaning energy carriers or input materials, in particular carbon-containing input materials, formed in the geological past from decomposition products of dead plants and animals. These include brown coal, bituminous coal, peat, natural gas and crude oil. Continuing renewability through re-growth is thus not possible for input materials of fossil origin.

Where it is specified that two or more input streams are simultaneously reacted in a chemical reactor this refers to two input streams being supplied to the reactor at the same time and—after reaction with the reaction partner, for example oxygen—a common reaction product being discharged from the reactor.

A synthesis gas having a high proportion of carbon monoxide/a CO-rich synthesis gas is to be understood as meaning a synthesis gas which as raw synthesis gas, i.e. directly at the exit of the synthesis gas production reactor, has a higher molar CO/H₂ ratio than a typical raw synthesis gas obtained by steam reforming from hydrocarbon-containing input streams, for example natural gas. In particular a synthesis gas having a high proportion of carbon monoxide/a CO-rich synthesis gas is to be understood as meaning a synthesis gas having a molar H₂/CO ratio of less than 2.1.

Pressures reported in the unit bar(a) relate to absolute pressure in bar absolute.

Pyrolysis oils are formed in the pyrolysis, in particular in the rapid pyrolysis (flash pyrolysis), of biomass as input material. Conversion to the pyrolysis products is carried out in the absence of oxygen and, especially in rapid pyrolysis, within just a few seconds at temperatures of about 400° C. to 600° C., typically around 500° C., to afford liquid (pyrolysis oil), solid (biocoke) and a residual fraction of gaseous or vaporous pyrolysis products. Details concerning the performance of the process may be found for example in the international patent applications WO 2003/033624 A1 and WO 2007/017005 A1 Rapid pyrolysis is a specific process mode with which high pyrolysis oil proportions coupled with little coke are achievable.

Pyrolysis oils are low-viscosity liquids having a dark red to dark brown colour. Their production and properties are described for example in the textbook “Energie aus Biomasse: Grundlagen, Techniken and Verfahren”, M. Kaltschmitt, H. Hartmann, Springer Verlag, Berlin (2001), page 491 ff. Accordingly, pyrolysis oils may contain up to 38% water which originates both from the residual moisture of the raw material and is formed by the cracking reactions. The pyrolysis oils consist mainly of a mixture of alcohols, furans, aldehydes, phenols, organic acids and oligomeric carbohydrate and lignin products. In terms of chemistry they therefore consist of several hundred individual components having the following functional groups: organic acids, aldehydes, esters, acetals, hemiacetals, alcohols, olefins, aromatics and phenols. The composition is dependent on the input material and the employed pyrolysis process, separation system and storage conditions. Compared to carbon carriers of fossil origin pyrolysis oils have a high oxygen proportion of typically around 40% to 60% by weight or, based on anhydrous oil, typically 20% to 30% by weight, whereas the oxygen proportion of light and heavy fuel oil is only in the trace range, for example 0.01% by weight.

The ash content of pyrolysis oils is typically 0.01% to 0.2% by weight and is thus slightly above that of light and heavy fuel oil of typically 0.01% by weight. Determination of ash content is carried out by normalized processes, for example according to the standard DIN 51719 (pyrolysis oil) or ISO 6245 (crude oil and crude oil descendent products).

Crude oil descendent products are to be understood as meaning all substances and substance mixtures obtained in one or more stages as target products (for example light and heavy fuel oil) or as by-products/waste products (for example heavy residues such as cracker residue) from crude oil.

A particular feature of the process according to the invention is the utilization of a low-ash and high-oxygen liquid biomass-derived input stream as a second input stream. Due to its low ash content it may therefore be employed in a lined high-temperature gasification reactor, thus making it possible to achieve a high cold gas efficiency. The high oxygen content in the molecular structure of the liquid biomass-derived input material makes it possible to achieve very low soot or coke formation during the reaction to afford synthesis gas. The liquid biomass-derived input material is preferably a pyrolysis oil.

It is a further particular feature of the process according to the invention that this liquid biomass-derived input material is supplied to the process in addition to natural gas or crude oil, a crude oil fraction or a crude oil descendent product as the first input stream and is reacted by simultaneous noncatalytic partial oxidation in the same reactor. This makes it possible to achieve an economically viable plant size.

It has been found that especially the production of carbon monoxide (CO) from natural gas by means of a noncatalytic partial oxidation of carbon-containing gases, for example natural gas, with simultaneous reaction of pyrolysis oil is particularly advantageous since this increases the carbon monoxide/hydrogen ratio in the raw synthesis gas without effecting a reduction in the hydrodynamic residence time which has a negative effect on the conversion in the reactor.

Providers of pyrolysis oil produced from biomass are well known in the market. The marketed pyrolysis oils have a water content-dependent heating value of typically 16 to 20 MJ/kg and only a very low nitrogen, sulfur and ash content. Their miscibility with water or hydrocarbons is very limited. With water a phase separation occurs above a water content of 25% to 30% by weight. These pyrolysis oils are only very slightly miscible with hydrocarbons. These oils thus cannot be mixed with hydrocarbons and supplied to a gasification together. Evaporation is not possible due to their reaction propensity for polymerization and cracking since this forms a coke-like solid.

In the process described herein pyrolysis oil is therefore supplied to the partial oxidation separately as a second input stream and therein converted simultaneously with the input stream and the oxidant into a raw synthesis gas. The first input stream may be a carbon-containing gas, for example natural gas, or a carbon-containing liquid, for example crude oil, a crude oil fraction or a crude oil descendent product.

The plant according to the invention comprises either a gas partial oxidation reactor or an oil partial oxidation reactor, preferably with a lined reaction chamber. According to the invention the addition of the pyrolysis oil is carried out via a separate feed conduit having suitable control means either to one or more burners in the reaction chamber or one or more separate injection means distinct from the burners.

In the case of addition via one or more burners the burners have a dedicated internal channel for the pyrolysis oil, wherein the burners also have internal channels for the first input stream, for the oxidant and optionally for a moderator, for example steam or carbon dioxide. The atomization of the pyrolysis oil may be carried out using the moderator or using the first input stream, if the latter is gaseous. It is particularly preferable when the internal supply channels are annular, with the exception of the innermost channel which has a circular cross section. The individual channels are preferably arranged coaxially/concentrically around the innermost channel. It is preferable when suitable configuration ensures that atomization of the second input stream is already effected in the burner interior, i.e. before exiting from the burner into the reaction chamber.

In the case of addition using one or more separate injection means distinct from the burners these are preferably configured as feed lances and arranged next to the one or more burners in the reaction chamber. In principle all possible mass ratios of first to second input stream are possible in this arrangement. However, preference is given in particular to feed mass flows of the second input stream of for example 1 to 10 t/h to take into account biomass availability.

In both cases of the addition of the second input stream it is preferable to provide the feed conduit with an atomization apparatus. Two-fluid atomizer nozzles, such as are described as part of a partial oxidation burner for liquid fuels for example in patent publications DE 10156980 A1 or EP 2523899 A1 have proven advantageous.

For further energy optimization of the process according to the invention or for reducing viscosity and thus improving conveyability the pyrolysis oil may be preheated. Numerous processes therefor are known. Due to the thermal instability of the pyrolysis oil, processes which ensure gentle preheating are especially suitable.

In a second aspect of the invention the process is characterized in that the cooling zone is configured as a quench or as a waste heat boiler or as a combination of both. Due to the typically low proportion of inorganic compounds in the pyrolysis oil, in particular potassium and calcium, it is advantageous to configure the cooling zone as a quench since potassium is partially in the gas phase under partial oxidation conditions and, when using a waste heat boiler for generating high-pressure steam can condense out in the heat exchanger tubes and thus lead to blockages. At the same time, the quench effects instantaneous cooling of the raw synthesis gas with the quench medium and the raw synthesis gas is depleted of particles, in particular of soot and coke particles. By contrast, a waste heat boiler is often more advantageous in respect of its higher efficiency of energy recovery. Particular preference is given to a combination of both cooling apparatuses, wherein a quench which ensures partial cooling and particle depletion is arranged first in the flow direction of the raw synthesis gas. A downstream waste heat boiler is used for further energy recovery; prepurification of the raw synthesis gas in the quench reduces the contamination risk for the waste heat boiler. This aspect also relates to a corresponding configuration of a plant.

When the cooling zone is configured as a quench it is further advantageous that the pyrolysis oil as a second input stream has a low ash proportion, wherein the ash proportion contains elements such as Na, K, Mg, Ca, which form basic/alkaline oxides/hydroxides. Since they undergo complete or partial dissolution in the quench water they increase the pH thereof and can neutralize acidic trace impurities in the synthesis gas, for example formic acid. This increases the service life of the employed materials of construction and/or more cost effective, less corrosion resistant materials may be employed.

In a third aspect of the invention the process is characterized in that the cooling zone is configured as a quench and that the process further comprises the steps of:

(e1) subjecting the hot raw synthesis gas stream in the cooling zone to a cold, water-containing quench medium stream to obtain a cold raw synthesis gas stream and a stream of hot quench medium,

(e2) discharging the hot, liquid quench medium stream from the cooling zone and introducing at least a portion of the hot quench medium stream into a first heat exchanger for cooling the hot quench medium stream by indirect heat exchange against a first coolant to obtain the cold quench medium stream,

(e3) discharging the cold quench medium stream from the first heat exchanger and recycling at least a portion of the cold quench medium stream to the cooling zone to form a quench medium stream circuit. This aspect also relates to a corresponding configuration of a plant.

This embodiment is based on the recognition that the hot quench medium stream can provide sufficient energy for preheating the carbon-containing input stream, the oxidant stream and an optional moderator stream. This embodiment makes it possible to utilize the water hitherto unused as a heat transfer medium. Especially for liquid inputs that are thermally unstable or have a propensity for coking, a hotspot-avoiding, highly uniform preheating to a temperature level of about 200° C. is possible. Especially when the input has a propensity for thermally induced reactions, for example polymerizations, as is the case for pyrolysis oil for example, the use of this heat transfer medium is advantageous since the preheating is effected to a lower temperature level than in the case of preheating with high-pressure steam.

In a fourth aspect of the invention the process is characterized in that the mass flow proportion of the second input stream based on the sum of the mass flows of the first and second input stream is at least 5% by weight, preferably at least 10% by weight. Due to the elevated oxygen proportion of the pyrolysis oil compared to fossil input materials the amount of the oxidant to be employed is significantly reduced as a result of this. When in addition the mass flow proportion of the second input stream based on the sum of the mass flows of the first and second input stream does not exceed a value of at most 40% by weight, preferably of at most 30% by weight, an existing plant for partial oxidation of the first input stream may easily be revamped by providing a feed conduit for the second input stream without needing to fundamentally alter the plant design, for example the reaction chamber and/or the cooling zone. This especially makes it possible to reduce the mass flow of the first input stream, for example of natural gas, while simultaneously increasing the mass flow of the second input stream, thus keeping the production capacity of the process/the plant constant but forming a synthesis gas richer in CO due to the higher C/H ratio of the second input stream.

In a fifth aspect of the invention the process is characterized in that the first input stream has an ash content of at most 5% by weight, preferably of at most 1% by weight, most preferably of at most 0.1% by weight. Since pyrolysis oil as the second input stream itself likewise has a low ash content of for example 0.01% to 0.20% by weight the solids separation from the raw synthesis gas may accordingly be made simpler and smaller or may be entirely dispensed with.

In a sixth aspect of the invention the process is characterized in that the first input stream comprises natural gas, crude oil or at least one liquid or gaseous crude oil descendent product. These input materials form the basis of partial oxidation processes such as are already known from the prior art, for example the textbook “Gasification”, C. Higman, M. van der Burgt, Gulf Professional Publishing, Elsevier (2003). Especially advantageous is the use of crude oil descendent products of low value, for example cracker residues, which would otherwise require costly and complex disposal.

In a seventh aspect of the invention the process is characterized in that the first input stream comprises crude oil or at least one liquid crude oil descendent product in each case comprising suspended or fluidized carbon-containing solids particles. These may be intrinsic, for example suspended solids fractions of the recited products or additionally added solids particles, for example coke particles obtained in the context of refinery or petrochemical processes or as solid products of biomass pyrolysis. What is important is that the specified ash contents, for example the ash contents disclosed with the fifth aspect of the invention, are not exceeded, in order to ensure the abovementioned advantages. The ash content relates to the sum of the ash contents of the crude oil/crude oil descendent product and the solids dispersed therein.

In an eighth aspect of the invention the process is characterized in that the second input stream has an ash content of at most 1% by weight, preferably of at most 0.2% by weight, most preferably of at most 0.1% by weight. This is generally unproblematic since pyrolysis oil as the second input stream itself likewise has a low ash content of for example 0.01% to 0.20% by weight. The solids separation from the raw synthesis gas may accordingly be made simpler and smaller or may be entirely dispensed with.

In a ninth aspect of the invention the process is characterized in that the second input stream has an oxygen content of at least 10% by weight, preferably of at least 20% by weight, most preferably of at least 30% by weight, in each case based on anhydrous pyrolysis oil. The high oxygen content in the molecular structure of the constituents of the pyrolysis oil as a liquid biomass-derived input material makes it possible to achieve a very low soot or coke formation during the reaction to afford synthesis gas since mass transfer limitations of the oxygen from the gaseous oxidant to the carbon-containing reaction partners especially in respect of limited residence time of the reaction mixture in the reactor are avoided. This significantly reduces the amount of the oxidant to be employed.

In a tenth aspect of the invention the process is characterized in that the second input stream is atomized before or during introduction thereof into the reaction chamber. The atomizing allows a uniform, low-soot and low-coke reaction of the pyrolysis oil during the partial oxidation since local carbon excesses based on the concentration of the oxidant present there are avoided. The atomization of the second input stream before or during introduction thereof into the reaction chamber further ensures good commixing with the first input stream. This also favors the uniform, low-soot and low-coke reaction of the first, fossil-derived input stream in the partial oxidation, said stream thus benefitting to a particular extent from the high oxygen content of the pyrolysis oil.

In an eleventh aspect of the invention the process is characterized in that the second input stream is atomized before or during introduction thereof into the reaction chamber, wherein the atomizing medium is:
the moderator stream and/or
at least a portion of the first input stream if said stream is gaseous.

Use of the gaseous first input stream, for example natural gas, likewise achieves the advantage of a uniform, low-soot and low-coke reaction on account of the high oxygen content of the pyrolysis oil which is thus intensively premixed with the first input stream during or before entry into the burner.

In a twelfth aspect of the invention the process is characterized in that the second input stream is introduced into the reaction chamber via the at least one burner, wherein the second input stream is introduced into the at least one burner via a separate conduit channel and atomized using the atomizing medium and introduced into the reaction chamber in the atomized state. The space-saving construction of a combined burner for the first and second input stream is advantageous. Separate feed lances for the second input stream are not required and are thus saved. In this embodiment the at least one burner is particularly preferably provided with a multiplicity of annular channels which coaxially and concentrically surround a central channel of circular cross section, wherein the second input stream is introduced into one of the annular channels and/or into the central channel.

In a thirteenth aspect of the invention the process is characterized in that the second input stream is introduced into the reaction chamber separately from the at least one burner via at least one separate feed lance, wherein the second input stream is atomized using the atomizing medium and introduced into the reaction chamber in the atomized state. It is advantageous that no alterations to the configuration of the burner are required compared to an operation of the partial oxidation reactor with only the first input stream. This moreover allows operating periods in which the partial oxidation reactor is supplied either with only the first input stream or with the first and the second input stream. In order to facilitate atomizing of the second input stream it is advantageous to provide the feed lances with an atomizing apparatus. Two-fluid atomizer nozzles for example, such as are described as part of a partial oxidation burner for liquid fuels in patent publications DE 10156980 A1 or EP 2523899 A1 for example, have proven advantageous for this purpose.

It is moreover advantageous in the embodiment according to the thirteenth aspect of the invention to mount the feed lances and burners on a common faceplate which is attached on the entry side of the reaction chamber. Feed lances and burners are thus particularly easy to unmount and subsequently remount for repairs and revisions.

In a fourteenth aspect of the invention the process is characterized in that the mass ratio of the atomizing medium to the second input stream is between more than zero and 1 g/g, preferably between 0.1 and 0.5 g/g. Investigations have shown that this results in a good compromise between effective, finely divided atomization of the second input stream on the one hand and acceptable dilution when using the moderator as the atomizing medium/acceptable excess of the first input stream on the other hand.

A fifteenth, sixteenth and seventeenth aspect of the invention relates to the configuration of a plant according to the first, second and third aspect of the process according to the invention and exhibits the advantages recited therein.

An eighteenth aspect of the invention relates to a process for retrofitting an existing plant for noncatalytic partial oxidation of a first, carbon-containing input stream of fossil origin as the first input stream, wherein the existing plant comprises the following constituents:

(a) means for providing the first carbon-containing input stream of fossil origin in fluid or fluidized form, means for providing the oxidant stream, optionally means for providing a moderator stream comprising steam and/or carbon dioxide,

(b) a partial oxidation reactor comprising a reaction chamber having an inlet and an outlet, at least one burner arranged at the inlet of the reaction chamber and a cooling zone arranged downstream of the outlet of the reaction chamber and in fluid connection therewith,

(c) means for introducing the first input stream, the oxidant stream and the optional moderator stream into the at least one burner and means for introducing the second input stream into the reaction chamber via the at least one burner or via a feed conduit separate from the at least one burner,

(d) means for discharging a hot raw synthesis gas stream from the reaction chamber and means for introducing same into the cooling zone,

(e) means for discharging a cold raw synthesis gas stream from the partial oxidation reactor,

characterized in that the existing plant is additionally provided with a feed for a pyrolysis oil as the second input stream, wherein the feed for the second input stream opens into the at least one burner or separately from the at least one burner opens directly into the reaction chamber and the feed is configured such that the second input stream is atomized before or during the introduction thereof into the reaction chamber.

This has the advantage that the existing plant for noncatalytic partial oxidation of the first carbon-containing input stream of fossil origin may largely reused. It is merely necessary to undertake modifications relating to the supply of the second input stream.

In a further aspect of the invention the process is characterized in that the cooling zone is configured as a quench and that the process further comprises the steps of:

(e1) subjecting the hot raw synthesis gas stream in the cooling zone to a cold, water-containing quench medium stream to obtain a cold raw synthesis gas stream and a stream of hot, liquid quench medium laden with solids particles,

(e2) discharging the hot, liquid quench medium stream laden with solids particles from the cooling zone and introducing at least a portion of the hot quench medium stream into a first heat exchanger for cooling the hot quench medium stream by indirect heat exchange against a first coolant to obtain the cold quench medium stream, wherein the first heat exchanger is selected from the group of:
crossflow heat exchangers, wherein the coolant is passed through tubes which have the hot quench medium stream flowing around them,
shell and tube heat exchangers, wherein the coolant flows through the tube side and the hot quench medium stream flows through the shell side,
spiral heat exchangers,
   wherein the first coolant is at least one material stream selected from the group of:

first input stream, second input stream, oxidant stream, moderator stream,

wherein the material stream or streams are preheated before introduction into the partial oxidation reactor,

(e3) discharging the cold quench medium stream from the first heat exchanger and recycling at least a portion of the cold quench medium stream to the cooling zone to form a quench medium stream circuit. This aspect also relates to a corresponding configuration of a plant.

Advantageous here is that the hot quench medium stream provides sufficient energy for preheating the carbon-containing input stream, the oxidant stream and an optional moderator stream and may be utilized as heat transfer medium with this embodiment even when laden with solids particles. Especially for liquid inputs that are thermally unstable or have a propensity for coking, a hotspot-avoiding, highly uniform preheating to a temperature level of about 200° C. is possible. Especially when the input has a propensity for thermally induced reactions, for example polymerizations, as is the case for pyrolysis oil for example, the use of this heat transfer medium is advantageous since the preheating is affected to a lower temperature level than in the case of preheating with high-pressure steam. This further allows preheating of a further operating medium stream and there is an additional degree of freedom in the adjustment of the preheating temperature for this additional operating medium stream.

In the context of the last-mentioned aspect of the invention it is further advantageous when the quench medium stream is supplied to an apparatus for solids separation before recycling to the cooling zone. This reduces the propensity for blocking of the apparatuses, for example nozzles, used for introducing the cold quench medium into the cooling chamber.

In a further aspect of the invention the process is characterized in that at least a second heat exchanger for cooling the hot quench medium stream by indirect heat exchange is present, wherein the second heat exchanger is operated with a second coolant selected from the group of: carbon-containing input stream, oxidant stream, moderator stream. This allows preheating of a further operating medium stream and there is an additional degree of freedom in the adjustment of the preheating temperature for this additional operating medium stream. This aspect also relates to a corresponding configuration of a plant.

In a further aspect of the invention the process is characterized in that the pressure in the reaction chamber and in the cooling zone is between 15 and 100 bar(a), preferably between 25 and 70 bar(a), and the gas temperature in the reaction chamber is between 1000° C. and 1800° C., preferably between 1250° C. and 1500° C. The chosen pressure is a function especially of the subsequent utilization of the synthesis gas while taking into account, for example, the cost and complexity of compression. The choice of pressure is moreover influenced by taking into account the volume of the required apparatuses, containers and pipes and the required wall thicknesses thereof. In terms of temperature the range between 1250° C. and 1500° C., in particular the range between above 1250° C. and 1450° C., represents the range at which the input streams are largely converted into synthesis gas so that in terms of thermodynamics and reaction kinetics the residual methane content is low and soot is also largely converted.

In a further aspect of the invention the process is characterized in that the preheating temperature of the carbon-containing input stream before introduction into the partial oxidation reactor is between 200° C. and 400° C. for gaseous input streams, between 150° C. and 300° C. for liquid input streams and between 20° C. and 150° C. for pyrolysis oil. Especially for natural gas as the first input stream the preheating temperature results from the requirements of the desulfurization arranged upstream of the gasification reactor, for example by adsorption on ZnO and optional hydrogenation. Typical operating temperatures for an adsorptive desulfurization on ZnO are around 300° C.

In a further aspect of the invention the process is characterized in that the preheating temperature of the oxygen-containing oxidant before introduction into the burner is between 120° C. and 250° C.

It would in principle be advantageous to choose the preheating temperature of the oxygen-containing oxidant to be as high as possible. At high temperatures suitable heat transfer media and suitable materials are required. When using pure oxygen as the oxidant the high reactivity thereof necessitates the use of corresponding oxidation resistant construction materials and it is necessary to take particular account of safety aspects, especially in the vicinity of the burner.

### BRIEF DESCRIPTION OF THE DRAWINGS

Developments, advantages and possible applications of the invention are also apparent from the following description of working and numerical examples and the drawings. All features described and/or depicted, either in themselves or in any combination, form the invention, regardless of the way they are combined in the claims or the back-references therein.

FIG. 1 shows an embodiment of a gasification process/a corresponding plant by noncatalytic partial oxidation (POX) according to the prior art,

FIG. 2 shows an embodiment of a gasification process by noncatalytic partial oxidation (POX) according to the invention,

FIG. 3 shows an embodiment of a burner for noncatalytic partial oxidation (POX) according to the invention,

FIG. 4 shows an example of an inventive embodiment of a burner faceplate having a plurality of burners and an injection lance.

### DETAILED DESCRIPTION OF PREFERRED EMBODIMENTS

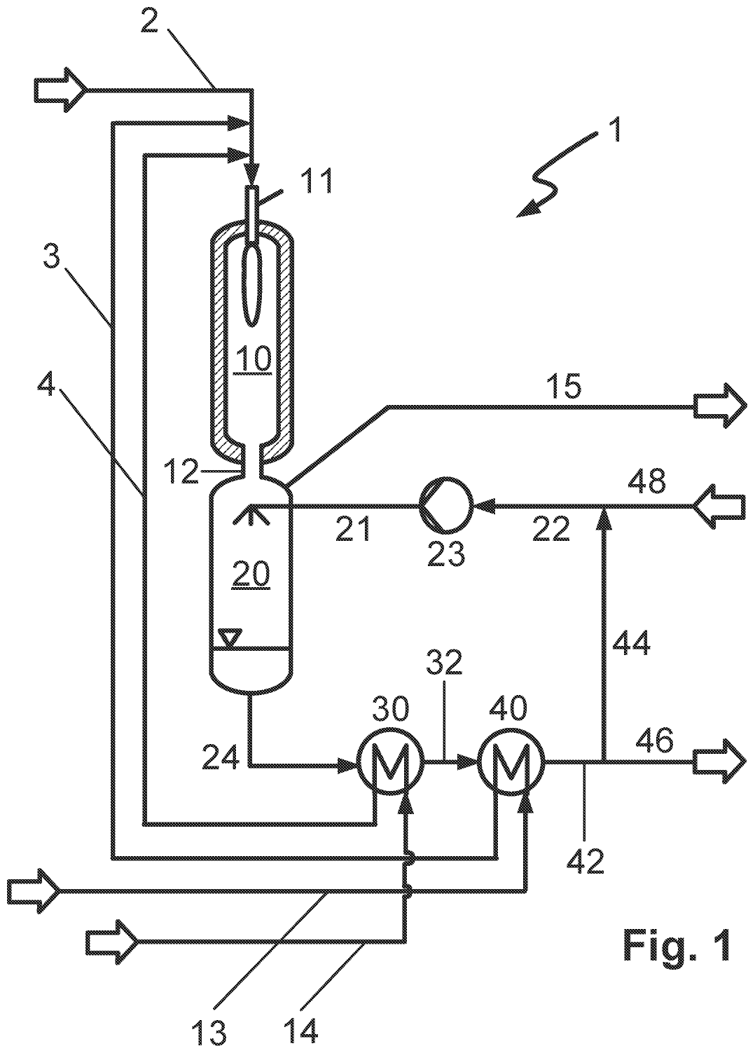

In the plant 1 shown schematically in FIG. 1 for synthesis gas production according to the prior art by noncatalytic partial oxidation for example of crude oil or a crude oil descendent product, for example a cracker residue, as a liquid, carbon-containing first input stream, the reaction chamber 10 is supplied via the burner 11 with the first input stream via conduits 13 and 3, with steam as moderator via conduit 2 and with oxygen as oxidant via conduits 14 and 4. The detailed media path is not depicted in the figure; thus a pre-mixing of one or more of the media, for example of the pyrolysis oil or the oxidant or both, with the moderator may be carried out upstream of the burner or in the burner itself, wherein steam or carbon dioxide or mixtures of these substances are used as the moderator.

The reaction of the first input stream with the oxidant to afford a raw synthesis gas is carried out under partial oxidation conditions in the burner 11 and/or in the reaction chamber 10 arranged downstream of the burner to afford a hot raw synthesis gas stream.

Via conduit 12 the raw synthesis gas enters the cooling chamber 20 which is configured as a quench. By spraying water which is supplied via conduits 21 and 22 as a cold quench medium stream, said quench instantaneously lowers the temperature of the raw synthesis gas to a temperature between 150° C. and 250° C. at a typical pressure between 25 and 80 bar(a). The thus obtained cooled raw synthesis gas largely freed of solids particles, for example soot or coke particles, is subsequently discharged from the partial oxidation plant via conduit 15 and sent for further processing or further treatment.

The hot, liquid quench medium optionally laden with solids particles collects in the lower region of the cooling chamber and forms a liquid fill level therein. The hot quench medium is then discharged from the cooling chamber 20 via conduit 24 and passed to the first heat exchanger 30 via conduit 24. If the hot quench medium is discharged at the lowest point of the cooling chamber 20 as shown and it contains a significant proportion of solids particles said medium is advantageously applied to an apparatus for solids separation (not shown) to separate at least a portion of the entrained solids particles before the hot quench medium is passed on to the first heat exchanger 30.

The first heat exchanger 30 performs a first partial cooling of the hot quench medium in indirect heat exchange against the oxidant stream supplied via conduit 14 as the first coolant which is thus preheated and passed to the burner 11 via conduit 4. The partially cooled quench medium is then passed to a second heat exchanger 40 via conduit 32. The second heat exchanger 40 performs the further partial cooling of the quench medium in indirect heat exchange against the first input stream supplied via conduit 13 as the second coolant which is thus likewise preheated and passed to the burner 11 via conduit 3.

The cold quench medium is discharged from the second heat exchanger 40 via conduit 42 and, via conduits 44, 22, 21 and pump 23, recycled as cold quench medium to the cooling chamber 20, thus forming a closed quench medium circuit. A small proportion compared to the recirculating mass flow of the quench medium is continuously discharged from the process via conduit 46 to limit contamination of the circulating quench medium by fine solids fractions and undesired dissolved substances. The discharged mass flow of the quench medium is continuously replaced by fresh water via conduit 48.

The specified choice of the first and the second coolant offers particular advantages: The oxidant less sensitive to overheating encounters the still-hot quench medium stream as the first coolant in the first heat exchanger while the already partially cooled quench medium is further cooled with the hydrocarbons-containing first input stream as the second coolant in the second heat exchanger. In this way the first input stream as a carbon-containing input stream is preheated, but overheating, which can result in undesired side reactions on account of the reactivity of several ingredients, is avoided.

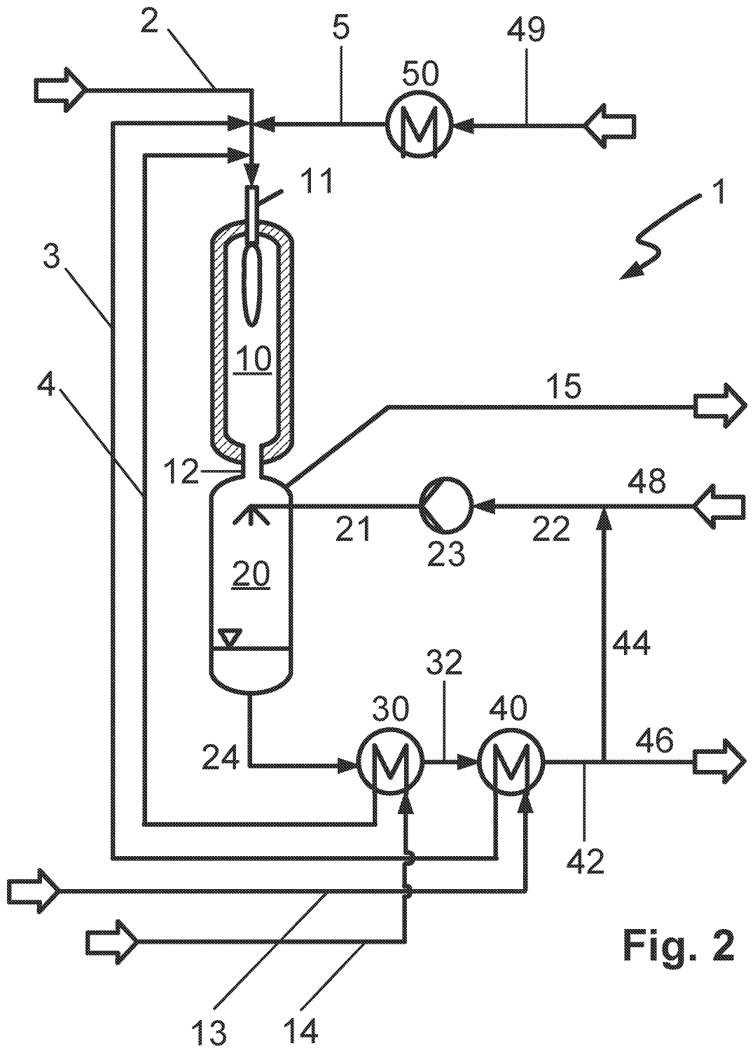

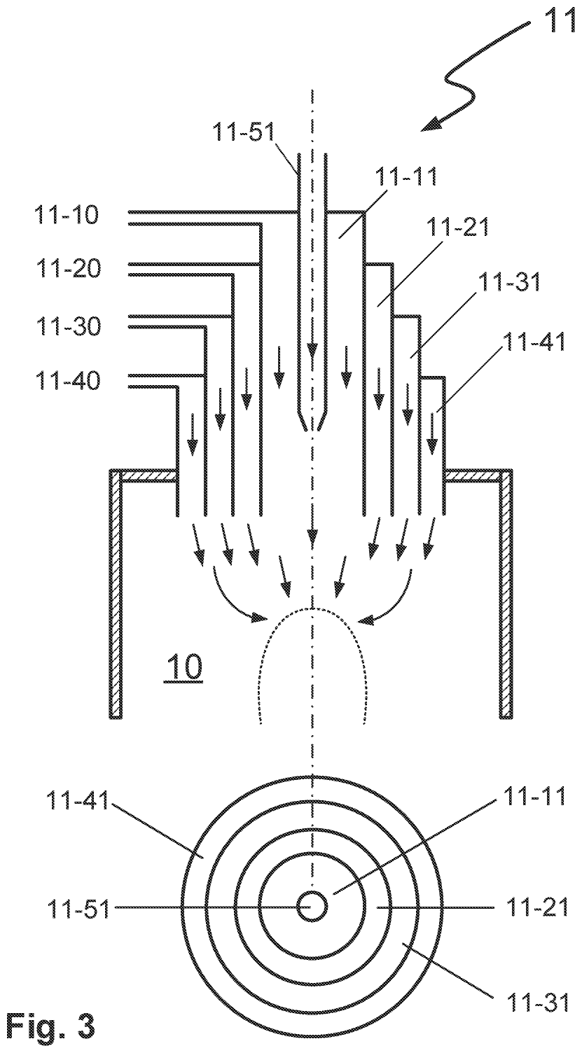

In the embodiment shown in FIG. 2 of a gasification process by noncatalytic partial oxidation (POX) according to the invention all depicted elements and the reference numerals therefor correspond to those in FIG. 1 to the extent that they have already been mentioned in connection with the embodiment elucidated therein. Added in novel and inventive fashion are conduits 5 and 49 by means of which a pyrolysis oil as a second input stream is passed to conduit 2 and on to the burner 11. The course of the second input stream shown in FIG. 2 is thus to be understood as being purely schematic; a more detailed example of the supply of the second input stream to the burner is shown below in FIG. 3.

Before being supplied to the burner the second input stream is preferably preheated, for example using a heat exchanger 50. Here too, the already partially cooled quench medium stream in conduit 32 or 42 for example may serve as heat transfer medium (not shown). It is particularly preferable to use the already relatively well cooled quench medium stream in conduit 42 as heat transfer medium for preheating the second input stream. In this way the second input stream as a carbon-containing input stream is preheated, but overheating, which can result in undesired side reactions on account of the reactivity of several ingredients, is avoided. Since the second input stream generally has a higher concentration of reactive ingredients having a propensity for undesired side reactions it is preferable to use a cooler heat transfer medium stream for the preheating of the second input stream than for the preheating of the first input stream. It is thus particularly preferable to arrange the heat exchanger 50 downstream of the heat exchanger 40 if the quench medium stream is to be used as heat transfer medium in both heat exchangers.

FIG. 3 shows schematically an example of the construction of a burner 11 according to an inventive embodiment of the invention. The inventive burner 11 depicted in side view in the upper portion of FIG. 3 is supplied with steam as moderator via conduit 11-10, with oxygen as oxidant via conduit 11-20, once more with steam as moderator via conduit 11-30 and with natural gas as a first input stream via conduit 11-40. The central conduit 11-51 is used to supply the burner with pyrolysis oil as a second input stream. The central conduit 11-51 is at its end configured as an atomizing apparatus and already before entry into the reaction chamber 10, i.e. still in the interior of the burner 11, opens into the annular channel 11-11 which coaxially and concentrically surrounds it and carries steam serving as atomizing medium for the second input stream, so that the pyrolysis oil is already atomized in the burner interior. The further annular channels 11-21 (oxygen), 11-31 (steam) and 11-41 (natural gas) are all likewise arranged coaxially and concentrically. This is depicted again in the lower portion of FIG. 3 as a plan view of a cross section through the burner. Natural gas, oxygen, steam as moderator and the mixture of moderator and atomized pyrolysis oil exit the burner via the corresponding conduits/annular channels and enter the reaction chamber as indicated schematically by flow arrows. Taking place in the reaction chamber is the partial oxidation reaction between the first and second input stream and the oxygen as oxidant with flame formation (shown as dotted line).

The inventive media path inside the burner ensures a uniform, low soot and low coke conversion of the first, fossil-derived input stream and the pyrolysis oil as the second input stream in the partial oxidation. The conversion of the first input stream benefits from the high oxygen content of the second input stream. The space-saving construction of a combined burner for the first and second input stream is also advantageous. Separate feed lances for the second input stream are not required and are thus saved.

Further constructive constituents of the burner, for example required cooling apparatuses and feeds for corresponding cooling media, are not shown in FIG. 3 due to the highly schematic representation. A person skilled in the art will supplement them with his knowledge of the art where required or advantageous.

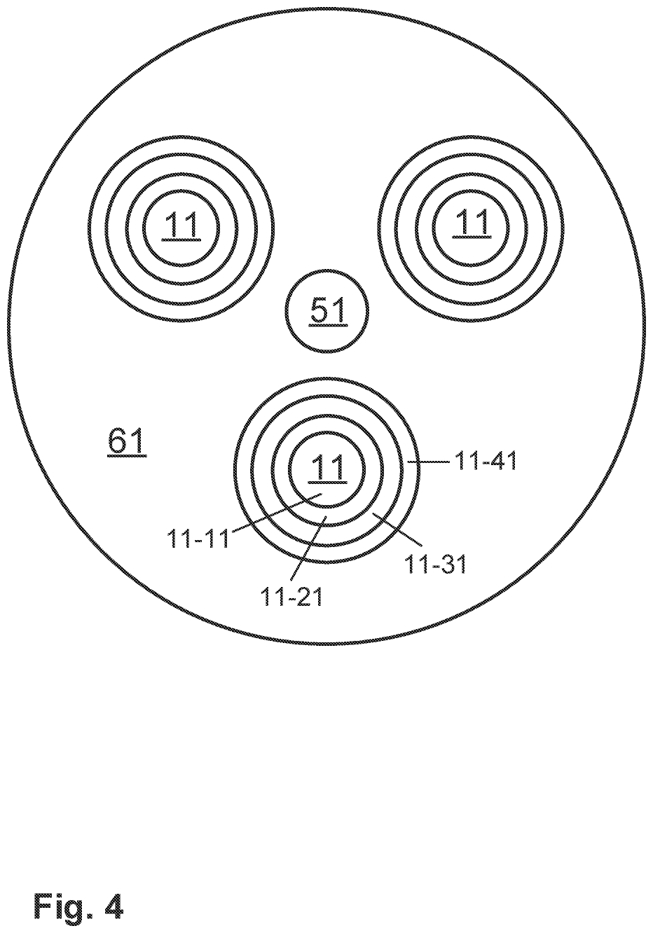

FIG. 4 shows schematically a further example of an inventive embodiment of the invention as a plan view of a cross section of the apparatus. Three burners 11 are symmetrically arranged on a common burner faceplate 61. The construction of the burners corresponds to that of FIG. 3 with the annular channels 11-11, 11-21, 11,31 and 11-41 but without the central conduit 11-51. The central conduit 11-51 may alternatively also be retained but now used for feeding the first feed stream, for example natural gas; it would then be possible to dispense with one annular channel, for example the annular channel 11-41.

Arranged in the center of the circular faceplate 61 is a feed lance for pyrolysis oil as the second input stream. The feed conduit for the atomizing medium, for example steam, is not depicted. Said feed conduit preferably surrounds the central feed conduit for the pyrolysis oil as an annular channel. Both feed conduits open into a two-fluid atomizer nozzle (not shown) as an atomizing apparatus. It is advantageous that no alterations to the configuration of the burner are required compared to an operation of the partial oxidation reactor with only the first input stream. This moreover allows operating periods in which the partial oxidation reactor is supplied either with only the first input stream or with the first and the second input stream.

Arrangement of the feed lances and the burner on a common faceplate attached on the entry side of the reaction chamber has the advantage that feed lances and burners are thus particularly easy to unmount and subsequently remount for repairs and revisions.

### NUMERICAL EXAMPLE

The following numerical example obtained by thermodynamic calculations shows the positive effect of the addition of pyrolysis oil as a second input stream in an existing plant for producing CO-rich synthesis gas by partial oxidation (POX) of natural gas as a first input stream.

In the comparative example a plant for noncatalytic partial oxidation (POX plant) having a thermal input power of 250 MW is considered as a base case without addition of pyrolysis oil. Preheated natural gas together with steam and recycle streams as input material is together with oxygen as oxidant converted into a raw synthesis gas. 29.2 t/h of CO and 3.8 t/h of H₂ are formed in the raw synthesis gas at the outlet of the reactor. The reactor is supplied with altogether 13.9 t/h of fossil carbon in the form of natural gas having a methane content of 93% by volume as the first input stream and therefore altogether 90% by weight of the carbon is passed to the partial oxidation in the form of methane.

In the inventive numerical example the POX plant is likewise supplied with natural gas having a methane content of 90% by volume as the first input stream but the first input stream is reduced to such an extent that the same mass of carbon monoxide in the raw synthesis gas is producible upon addition of 5.3 t/h of pyrolysis oil having a heating value of 20 MJ/kg (as supplied, comprising 18% by weight water) and a carbon content of 54.6% by weight (anhydrous) as the second input stream. The first input stream may accordingly be reduced to 85% so that only 11.8 t/h of the carbon carrier of fossil origin need be employed to produce a particular CO mass flow. The thermal input power of the plant is thus reduced to 242 MW. The required oxygen amount at identical reactor temperature is simultaneously reduced by 6%. The mass of hydrogen produced is thus reduced slightly by 6% but remains 3.7 t/h. This results in an increase in the CO/H₂ ratio in the synthesis gas by 6%.

If the proportion of renewable products of non-fossil origin is calculated as the difference between the inventive numerical example and 85% of the comparative example a regenerative and thus CO₂-free proportion of altogether produced CO of 15% and H₂ of 10% may be determined. In addition to the 6% reduction in oxygen demand in the gasification the same amount of CO is producible at a fossil carbon demand reduced by 2.4 t/h.

The invention is especially also suitable for retrofitting existing plants for low-CO₂ synthesis gas production. In this case additional CO and H₂ may be produced from biomass at minimal capital cost.

A further advantage is realized for plants whose main product is CO. In these plants the raw synthesis gas from the gasification stage is first freed of CO₂ typically in a scrub and then in a cryogenic process (so-called coldbox) separated into the product CO and a residual gas. By increasing the CO/H₂ ratio in the raw synthesis gas while maintaining a constant total amount of raw synthesis gas an existing plant retrofitted according to the invention makes it possible to produce more CO product and/or achieves lower consumption numbers for the overall process.

### LIST OF REFERENCE SYMBOLS

1 Plant

2-5 Conduit

10 Reaction chamber of partial oxidation reactor

11 Burner

11-10 Conduit

11-20 Conduit

11-30 Conduit

11-40 Conduit

11-11 Annular channel

11-21 Annular channel

11-31 Annular channel

11-41 Annular channel

11-51 Central conduit

12-15 Conduit

20 Cooling chamber of partial oxidation reactor

13-15 Conduit

21-22 Conduit

23 Pump

24 Conduit

30 First heat exchanger

32 Conduit

40 Second heat exchanger

42-49 Conduit

50 Third heat exchanger

51 Feed lance

61 Faceplate

What is claimed is:

1. A process for producing a hydrogen- and carbon oxides-comprising raw synthesis gas by simultaneous noncatalytic partial oxidation of
a fluid or fluidizable carbon-containing input stream of fossil origin as a first input stream and
a second input stream comprising a pyrolysis oil obtained from biomass with an oxygen-containing oxidant in a common noncatalytic partial oxidation reactor, comprising the steps of:
(a) providing the first input stream in fluid or fluidized form, providing the second input stream in liquid, conveyable form, providing an oxidant stream,
(b) providing a partial oxidation reactor comprising a reaction chamber having at least one inlet and an outlet, at least one burner arranged at the at least one inlet of the reaction chamber and a cooling zone arranged downstream of the outlet of the reaction chamber and in fluid connection therewith,
(c) introducing the first input stream, and the oxidant stream into the reaction chamber via the at least one burner and introducing the second input stream into the reaction chamber via the at least one burner or via a feed conduit separate from the at least one burner,
(d) at least partially reacting the first input stream and the second input stream with the oxidant stream under partial oxidation conditions in the burner and/or in the reaction chamber arranged downstream of the burner to afford a hot raw synthesis gas stream,
(e) discharging the hot raw synthesis gas stream from the reaction chamber and introducing same into the cooling zone,
(f) discharging the cold raw synthesis gas stream from the cooling zone and from the partial oxidation reactor for further processing or further treatment.

2. The process according to claim 1, wherein the cooling zone is configured as a quench or as a waste heat boiler or as a combination of both.

3. The process according to claim 1, wherein the cooling zone is configured as a quench and that the process further comprises the steps of:
(e1) subjecting the hot raw synthesis gas stream in the cooling zone to a cold, water-containing quench medium stream to obtain a cold raw synthesis gas stream and a stream of hot quench medium,
(e2) discharging the hot, liquid quench medium stream from the cooling zone and introducing at least a portion of the hot quench medium stream into a first heat exchanger for cooling the hot quench medium stream by indirect heat exchange against a first coolant to obtain the cold quench medium stream,
(e3) discharging the cold quench medium stream from the first heat exchanger and recycling at least a portion of the cold quench medium stream to the cooling zone to form a quench medium stream circuit.

4. The process according to claim 1, wherein the mass flow proportion of the second input stream based on the sum of the mass flows of the first and second input stream is at least 5% by weight.

5. The process according to claim 1 wherein the first input stream has an ash content of at most 5% by weight.

6. The process according to claim 1, wherein the first input stream comprises natural gas, crude oil or at least one liquid or gaseous crude oil descendent product.

7. The process according to claim 1, wherein the first input stream comprises crude oil or at least one liquid crude oil descendent product in each case comprising suspended or fluidized carbon-containing solids particles.

8. The process according to claim 1, wherein the second input stream has an ash content of at most 1% by weight.

9. The process according to claim 1 wherein the second input stream has an oxygen content of at least 10% by weight, in each case based on anhydrous pyrolysis oil.

10. The process according to claim 1, wherein the second input stream is atomized before or during introduction thereof into the reaction chamber.

11. The process according to claim 1, wherein the second input stream is atomized before or during introduction thereof into the reaction chamber, wherein the atomizing medium is:
the moderator stream and/or
at least a portion of the first input stream if said stream is gaseous.

12. The process according to claim 1, wherein the second input stream is introduced into the reaction chamber via the at least one burner, wherein the second input stream is introduced into the at least one burner via a separate conduit channel and atomized using the atomizing medium and introduced into the reaction chamber in the atomized state.

13. The process according to claim 1, wherein the second input stream is introduced into the reaction chamber separately from the at least one burner via at least one separate feed lance, wherein the second input stream is atomized using the atomizing medium and introduced into the reaction chamber in the atomized state.

14. The process according to claim 1, wherein the mass ratio of the atomizing medium to the second input stream is between more than zero and 1 g/g.

15. A plant for producing a hydrogen- and carbon oxides-comprising raw synthesis gas by simultaneous noncatalytic partial oxidation of
a solid, liquid or gaseous carbon-containing input stream of fossil origin as a first input stream and
a pyrolysis oil as a second input stream
with an oxygen-containing oxidant in a common noncatalytic partial oxidation reactor, wherein the plant comprises the following constituents in fluid connection with one another:
(a) a means for providing the first input stream in fluid or fluidized form, means for providing the second input stream in liquid, conveyable form, means for providing the oxidant stream,
(b) a partial oxidation reactor comprising a reaction chamber having an inlet and an outlet, at least one burner arranged at the inlet of the reaction chamber and a cooling zone arranged downstream of the outlet of the reaction chamber and in fluid connection therewith,
(c) a means for introducing the first input stream, the oxidant stream and the optional moderator stream into the at least one burner and a means for introducing the second input stream into the reaction chamber via the at least one burner or via a feed conduit separate from the at least one burner,
(d) a means for discharging a hot raw synthesis gas stream from the reaction chamber and means for introducing same into the cooling zone,
(e) a means for discharging a cold raw synthesis gas stream from the partial oxidation reactor.

16. The plant according to claim 15, wherein the cooling zone is configured as a quench or as a waste heat boiler or as a combination of both.

17. The plant according to claim 15, wherein the cooling zone is configured as a quench and the plant also comprises the following constituents:
(e1) a means for subjecting the hot raw synthesis gas stream in the cooling zone to a cold, water-containing quench medium stream,
(e2) a first heat exchanger, a means for discharging a hot liquid quench medium stream and a cold raw synthesis gas stream from the cooling zone and a means for introducing at least a portion of the hot quench medium stream into the first heat exchanger,
(e3) a means for discharging a cold quench medium stream from the first heat exchanger and a means for recycling at least a portion of the cold quench medium stream to the cooling zone to form a quench medium stream circuit.

18. A process for retrofitting an existing plant for noncatalytic partial oxidation of a first, carbon-containing input stream of fossil origin as the first input stream, wherein the existing plant comprises the following constituents:
(a) a means for providing the first carbon-containing input stream of fossil origin in fluid or fluidized form, means for providing the oxidant stream,
(b) a partial oxidation reactor comprising a reaction chamber having an inlet and an outlet, at least one burner arranged at the inlet of the reaction chamber and a cooling zone arranged downstream of the outlet of the reaction chamber and in fluid connection therewith,
(c) a means for introducing the first input stream, the oxidant stream and the optional moderator stream into the at least one burner and means for introducing the second input stream into the reaction chamber via the at least one burner or via a feed conduit separate from the at least one burner,
(d) a means for discharging a hot raw synthesis gas stream from the reaction chamber and means for introducing same into the cooling zone,
(e) a means for discharging a cold raw synthesis gas stream from the partial oxidation reactor,
wherein the existing plant is additionally provided with a feed for a pyrolysis oil as the second input stream, wherein the feed for the second input stream opens into the at least one burner or separately from the at least one burner opens directly into the reaction chamber and the feed is configured such that the second input stream is atomized before or during the introduction thereof into the reaction chamber.
